(19) United States
(12) Patent Application Publication
(10) Pub. No.: US 2002/0091556 A1
(43) Pub. Date: Jul. 11, 2002

(54) Systems and methods for travel networking

(75) Inventors: Geoffrey G. Fiala, Huntington Beach, CA (US); Yuri Vanetik, Lemon Heights, CA (US)

Correspondence Address: LYON & LYON LLP, 633 WEST FIFTH STREET, SUITE 4700, LOS ANGELES, CA, 90071, US

(73) Assignee: OnePub.com.Inc.

(21) Appl. No.: 09/756,366

(22) Filed: Jan. 8, 2001

(51) Int. Cl. G06F 17/60

(52) U.S. Cl. 705/6; 705/5

(57) ABSTRACT

Systems and methods for facilitating communication between members of online communities based upon shared travel-related interests are provided. A member database includes identities of members and geographic data related to respective members, e.g., residence locations, travel destinations of interest, and/or specific travel plans. Members may search the member database for other members having associations with selected travel destinations. For example, a member may search for members planning to travel to a destination at the same time as the searching member, for members who reside at a travel destination to which the searching member plans to travel, or for members traveling to the searching member's hometown. Messages may then be conveyed between the members related to their common travel-related plans and interests. If the members belong to different online communities, the member database may include surrogate identities of members by which members are exclusively identified to provide “blind” communication between members.

### FIELD OF THE INVENTION

The present invention relates generally to systems and methods for facilitating communication between members of online communities, and more particularly to providing communication and other interpersonal contact between members of online communities based upon shared travel-related interests.

### BACKGROUND

Social interaction via a network, such as the Internet, and more particularly the World Wide Web, has become increasingly popular. To facilitate communication between individuals, a variety of social communities have evolved on the Web, ranging from bulletin board systems, chat rooms, to membership-based service providers. Membership-based services, such as online “singles” or other dating services, allow members to search for other members with whom they may be interested in initiating contact. Such contact may range from simply becoming “penpals” sharing common interests to seeking long-term personal relationships.

Members of online communities may submit information on themselves and/or may search member databases for members to contact. To provide this information, members must generally answer many questions regarding their appearance, age, where they live, their lifestyle, hobbies, activities, relationship preferences, and the like. This information, however, is generally static and may not reflect recent activities or opportunities for in-person contact. In particular, members may not be able to share travel-related interests, other than simply identifying general interests, such as “I love Paris,” in a membership profile.

In addition, this information may be accessed only by members of the particular service provider to which the member belongs. Further, once a member has found another member of interest, the member must generally initiate contact with the member of interest by sending an e-mail or other correspondence identifying themselves and their association with their service provider.

Accordingly, systems and methods for facilitating communication between members of online communities based upon common travel-related interests would be considered useful.

### SUMMARY OF THE INVENTION

The present invention is directed to systems and methods for facilitating communication between members of online communities, and/or for providing communication and other interpersonal contact between members of online communities based upon shared travel-related interests.

In accordance with one aspect of the present invention, a system is provided for facilitating contact between members of one or more online social communities residing at different geographic locations, e.g., via an electronic network, such as the Internet. The system includes a member database including identities of members and geographic data related to respective members. The geographic data generally includes residence locations of respective members, travel destinations of interest to the respective members, and/or specific travel plans of respective members. The member database may also include personal or demographic data related to respective members.

A search engine is provided for searching the member database for members satisfying submitted search requests. An interface, e.g., a server connected to the network, is also provided for receiving search requests from members searching for other members having associations with identified travel destinations. The search requests may be relayed to the search engine, which may search the member database for members satisfying the search requests. The interface is configured for submitting search result lists from the search engine, including groups of identities of members having associations with the travel destinations. In addition, the system may also include a message server for conveying messages between the members.

For example, the system may be used for initiating contact between a first member of a social community residing at a first geographic location and a second member of the social community residing at a second geographic location via the network. A search request may be received from a first member searching for other members having an association with an identified travel destination. The member database may be searched for members satisfying the search request, and a list may be sent to the first member, the list including a group of identities of members having an association with the identified travel destination.

Preferably, a travel destination of interest to the first member may be identified, which is preferably different from at least one of the first and second destinations. A search request may then be submitted by the first member to the member database searching for members having an association with the identified travel destination.

For example, the search request may be directed to a geographic travel destination to which the first member plans to travel. In particular, the search request may seek members who also plan to travel to the identified travel destination. Further, the search request may seek members who also plan to travel to the identified travel destination at a time within a predetermined date restriction. Alternatively, the search request may seek members who reside at a travel destination to which the first member plans to travel. In a further alternative, the search request may seek members traveling to the first member's residence location, i.e., hometown.

In addition, the search request may be further limited based upon personal or demographic parameters, such as age, appearance, marital status, sexual preferences, interests, hobbies, and the like.

A list may be received by the first member including a group of members having an association with the identified travel destination, the group including the second member. The first member may then send a message to the second member, the message including information related to the identified travel destination.

In a preferred method, where the search request further includes a date restriction, the search results may include a group of members who have indicated that they plan to be present at the identified travel destination at a time included within the date restriction. The message from the first member may then include a notice from the first member that they also plan to be at the identified travel destination during a time within the date restriction.

In a preferred embodiment, the first and second members are members of different social communities sharing the member database. The member database may then also include surrogate identities of members, in addition to geographic data and/or personal information. The list sent to a searching member, e.g. the first member discussed above, may include a group of members having an association with the travel destination identified only by their surrogate identities.

When messages are sent between the first member and a second member, both members are preferably identified by their respective surrogate identities. The true identities of the members may be determined based upon the surrogate identities, e.g., by consulting the member database, and the messages may then be forwarded to the appropriate members.

Other objects and features of the present invention will become apparent from consideration of the following description taken in conjunction with the accompanying drawings.

### BRIEF DESCRIPTION OF THE DRAWINGS

For a better understanding of the invention, and to show how it may be carried into effect, reference will be made, by way of example, to the accompanying drawings, in which:

FIG. 1 is a block diagram, showing a system for facilitating contact between members of an online community based upon travel-related interests stored within a member database, in accordance with the present invention.

FIGS. 2 and 3 are flowcharts, showing a series of inquiries for submitting geographic data for entry in a member database, in accordance with the present invention.

FIG. 4 is an exemplary set of geographic data that may be included in a member database, in accordance with the present invention.

FIG. 5 is a flowchart, showing a method for searching a member database based upon travel-related interests, in accordance with the present invention.

FIG. 6 is a block diagram showing a second system for facilitating contact between members of different online social communities based upon travel-related interests stored in a member database, in accordance with the present invention.

### DETAILED DESCRIPTION

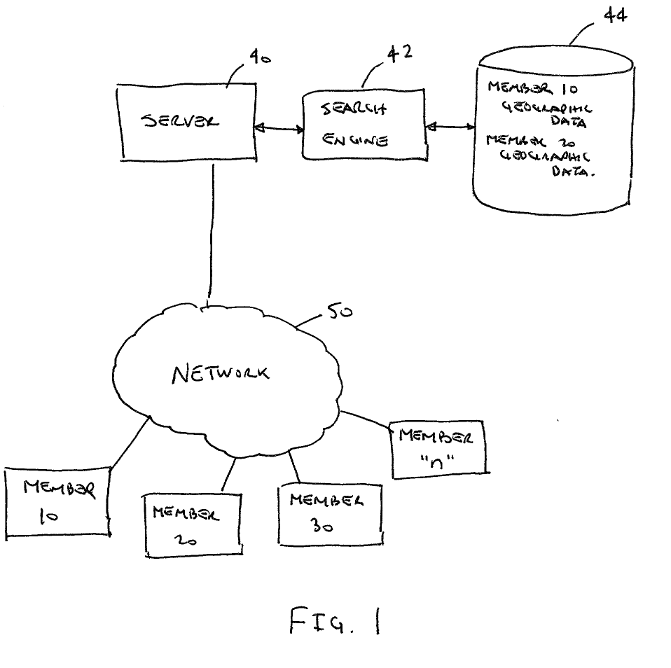

Turning to the drawings, FIG. 1 shows an exemplary architecture for searching for individuals sharing travel-related interests, in accordance with the present invention. A plurality of members 10, 20, 30, n are connected to a server 40 via an electronic network 50. The members 10-n generally communicate via the network 50 using a computer or other electronic device (not shown) including conventional hardware and/or software components. The server 40 is connected to a search engine 42 and a member database 44, which are configured for compiling, storing, and/or retrieving information related to the members 10-n. Alternatively, a plurality of servers and/or databases (not shown) may be connected to one another either directly or via the network 50, as will be appreciated by those skilled in the art.

In one embodiment, the network 50 may be a wide area network (“WAN”), a local area network (“LAN”), an Intranet, or a wireless communications network. Preferably, the network 50 may include several different types of networks, including, but not limited to, a WAN, a LAN, and/or a wireless network. For example, one such network including multiple different types of networks is the Internet, and more particularly the World Wide Web.

In a preferred embodiment, the members 10-n are participants in an online social community, such as a general Internet service provider, or a specialized service provider, such as an online “singles” or other dating service. The community may be available to any interested persons and/or may involve payment of membership fees to participate. Thus, the members 10-n may include a variety of computer users having access to the network 50, with access to the member database 44 being controlled by the operator of the community server 40. The community may include any number of members, as illustrated by member n.

When individual members join an online social community, they generally submit demographic or personal information about themselves. For example, they may submit information regarding their age, appearance (e.g., height, weight, eye color, hair color, etc.), where they live, their interests, hobbies, lifestyle, marital status, relationship preferences, and the like. This personal information may be submitted using any known method, for example, over a global electronic network, e.g., the Internet, over a telecommunications network, and the like. For example, the members may answer a series of questions either through a web page interface or by completing hard copies of questionnaires.

In addition, in accordance with the present invention, the members also generally submit geographic data, which may include present and/or past residence locations, and general travel-related information, such as past travel destinations, travel destinations of interest, and the like. Preferably, the geographic data also includes date-specific travel-related information, such as individual travel destinations, travel schedules, and/or purposes of travel, as described further below. Depending upon the structure of the online community, the individual members may first need to agree to provide this travel-related information and/or participate in this travel networking aspect of the community when they join the community. Alternatively, the members may opt in or out of providing this information and participating at any time.

The geographic data for all of the participating members may be compiled into a special geographic database, a general member database, and/or other database, such as the database 44 shown generally in FIG. 1. This database 44 may then be searched and/or accessed by members of the community, for example, using the search engine 42, as described further below.

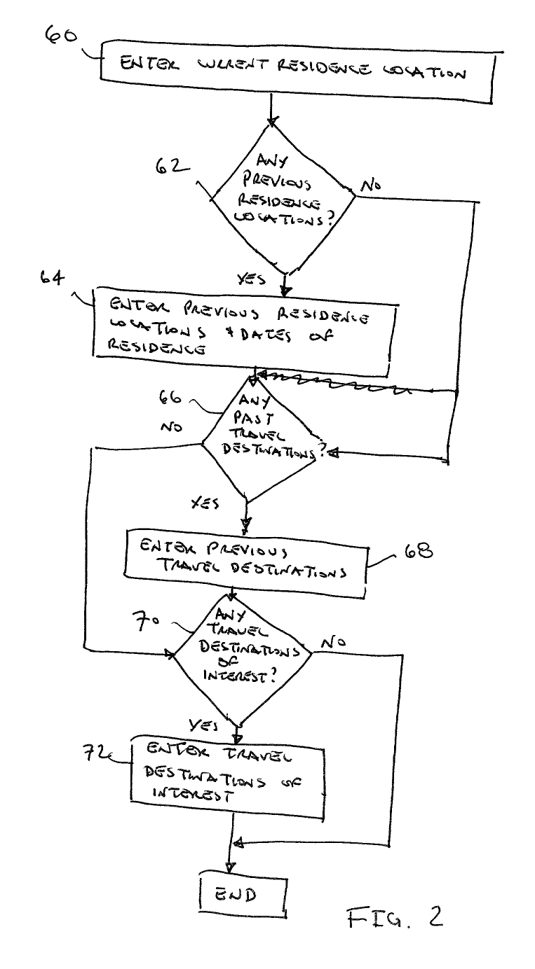

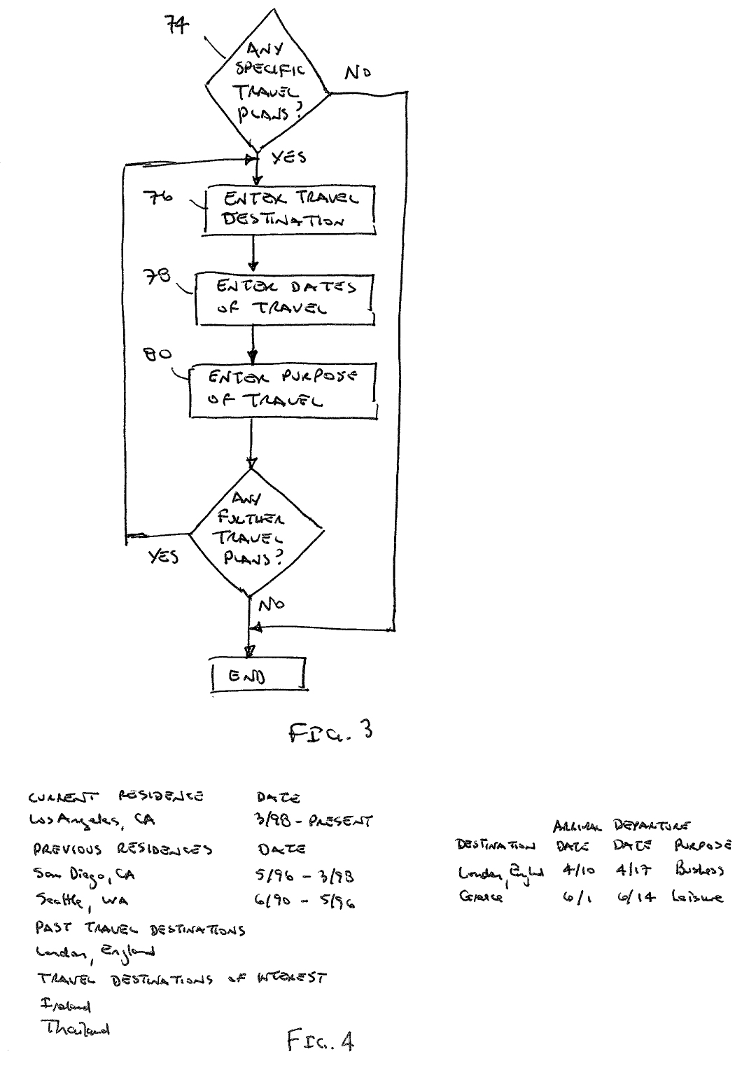

Turning to FIGS. 2-4, an exemplary series of travel-related inquiries are shown that may be presented to members of the community, for example, via a web page interface. The first set of inquiries (FIG. 2) relate to general geographic information, while the second set of inquiries (FIG. 3) relate to specific travel plans. FIG. 4 shows an exemplary set of general geographic and specific travel destination data that may be submitted in response to these inquiries.

First, with particular reference to FIG. 2, at step 60, a participating member may be asked to submit their current residence location. This may include their home city, town, or other locale, state, country, and the like. For example, the exemplary data in FIG. 4 reflects a member living in “Los Angeles, Calif.” The member may also be asked to include their initial date of residence at their current location, e.g., “March 1998 to present.” Alternatively or in addition, they may indicate whether or not they are new to the area of their current residence location, whether or not they know the area well, and other like information (not shown).

Next, at step 62, they may be asked whether they have any previous residence locations to include. If the answer to this inquiry is “Yes,” they may enter one or more previous residence locations at step 64. For example, the exemplary response indicates that a member resided in “San Diego, Calif.” from “May 1996 to March 1998” and “Seattle, Wash.” from “June 1990 to May 1996.”

At step 66, the member may be asked whether the member has any past travel destinations to include. If so, at step 68, the member may enter specific travel destinations, such as “London, England,” and, optionally, may include additional information, such as purpose of the travel, time of year of past visits, number of visits, lengths of the visits, and the like (not shown).

In addition, at step 70, the member may be asked whether the member has any specific travel destinations of interest, e.g., for possible future travel. If “Yes,” at step 72, the member may provide travel destinations of interest, which may be limited in number, prioritized based upon level of interest, and the like. For example, the exemplary response indicates an interest in “Ireland” and “Thailand.”

With reference to FIG. 3, at step 74, the member may be asked whether the member has any specific future travel plans. If “Yes,” the member may be asked to provide a specific travel destination at step 76 and the dates of the visit to the travel destination at step 78, i.e., date of arrival and/or date of departure. In addition, the member may be asked the purpose of the visit at step 80, such as whether it is for business or leisure. Other information regarding the member's trip to the travel destination may be included, e.g., that the member may be traveling with others, that the member would be interested in having someone show the member around, and the like (not shown). For example, as shown in FIG. 4, a member may indicate that they plan to travel to “London, England” arriving “April 10” and departing “April 17,” and that the purpose of the trip is “business.” At step 82, the member may indicate whether they have additional travel plans, for example, that they plan to travel to “Greece” from “June 1 to June 14,” and that the purpose of the trip is “leisure.”

It will be appreciated by those skilled in the art that these steps may be completed in any order and/or that one or more of these steps may be eliminated, if desired. In addition, once the database is compiled, it may be updated by members, e.g., using methods similar to those described above for initially submitting the geographic data. For example, individual members may periodically add new travel plans, modify existing travel plans, and/or delete canceled travel plans from their respective geographic data.

Members of the online community may then search the database in order to initiate contact with other members of the community based upon travel-related interests. For example, a member may search for other members traveling to their home city, traveling to a common travel destination at the same time, who have traveled to a selected travel destination previously, residing at a travel destination to which the member intends to travel, and the like. Thus, a first member of a social community residing at a first geographic location may search for and/or initiate contact with a second member of the social community residing at a second geographic location based upon common travel-related interests.

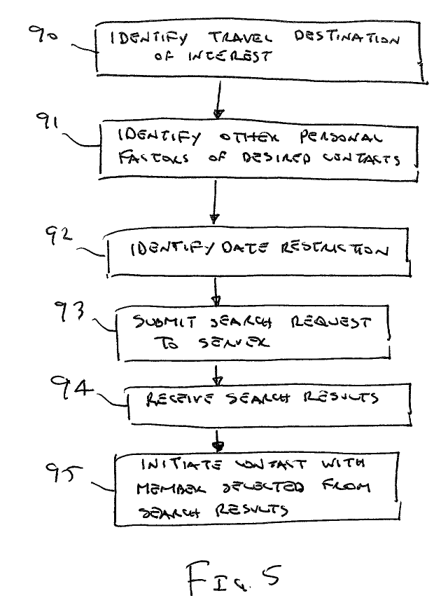

An exemplary method for initiating such contact is shown in FIG. 5. First, at step 90, a travel destination of interest is identified by the first member. This travel destination may be the residence location of the first member, the residence location of another member, or a travel destination different from these two residence locations, such as a vacation destination or other geographic location.

At step 91, the first member may optionally limit the search further. For example, the first member may identify one or more personal or demographic parameters related to members of interest to the first member, such as their sex, age, appearance (e.g., height, weight, eye color, hair color), ethnicity, nationality, interests, hobbies, and the like. In addition, the search may be limited in other ways, such as exclusively to members having the identified travel destination as their residence location.

At step 92, the first member may also identify a date restriction. For example, if the first member plans to travel to the identified travel destination between specific dates, the first member may want to limit the search to members who are also planning to be present at the identified travel destination at the same time, e.g., also traveling to the identified travel destination or already residing there.

Once the desired search parameters are identified by the first member, the first member may send a search request including the parameters to a server, such as the server 40 of FIG. 1 via the network 50. The server 40 may submit the search request to the search engine 42, which may search the member database 44 using known algorithms. Thus, the search engine 42 may search the member database 44 for members having an association with the identified travel destination. The search may also be further restricted based upon identified personal parameters, specified date restrictions, or other parameters identified by the first member.

Once the search is complete, the server 40 may send a search result to the first member, e.g., via the network 50. The search result generally includes a list of members (if any) satisfying the search request. The list includes identifiers of members having an association with the travel destination and/or best matching the identified personal factors, e.g., based upon known statistical search algorithms. For example, the list may be ranked based upon which members best match the search parameters. The member identifiers provided in the list may include membership aliases, e-mail addresses, personal addresses, telephone numbers, or other contact destinations. The degree of anonymity of the members included in the list is generally controlled by the operator of the server 40 and/or member database 44.

At step 94, the first member may receive and review the list to identify potential members of interest. The first member may select individual members from the list, and view details of their personal information and/or geographic data. If desired, the first member may further restrict, redefine, or otherwise modify the search, e.g., if the list is too long, too short, or does not provide useful results. For example, the first member may further limit the search based upon one or more of the parameters described above, e.g., until a desired number of matches are received.

Once the first member has identified a second member of interest from the list, the first member may initiate contact with the second member. For example, the first member may send a message to the second member using their membership alias via the server 40. For example, if the list includes membership aliases used by members of the community, the server 40 may receive the message, identify the second member based upon the alias included in the message, and relay the message to the second member. The message may include the membership alias used by the first member, rather than the true identity of the first member. Thus, some level of anonymity may be maintained between the members. Alternatively, a message may be sent directly to the second member, e.g., to their e-mail address or other contact destination available from the search results.

The message generally includes information related to the identified travel destination, and may be the first of many messages exchanged between the members. For example, if the identified travel destination is the second member's residence location, the first member may notify the second member that the first member plans to travel there. The first member may simply want to casually chat with the second member and/or ask for information about the second member's residence location, e.g., places to stay, eat, visit, and the like. Alternatively, the first member may inquire whether the second member would be interested in meeting in person, e.g., to show the first member around and/or to develop an in-person relationship. If the identified travel destination is the first member's residence location, the first member may offer to provide similar information to the second member and/or propose meeting in person.

Alternatively, if the identified travel destination is a destination to which the second member has previously traveled, the first member may ask questions about places to stay, eat, visit, and the like, about what to expect, e.g., in terms of weather, culture, etc., or other information about the identified travel destination. In a further alternative, if the first and second members both plan to be present at the identified travel destination on specified dates, the first member may invite the second member to meet there, to consider traveling together, and/or to become involved in an in-person relationship.

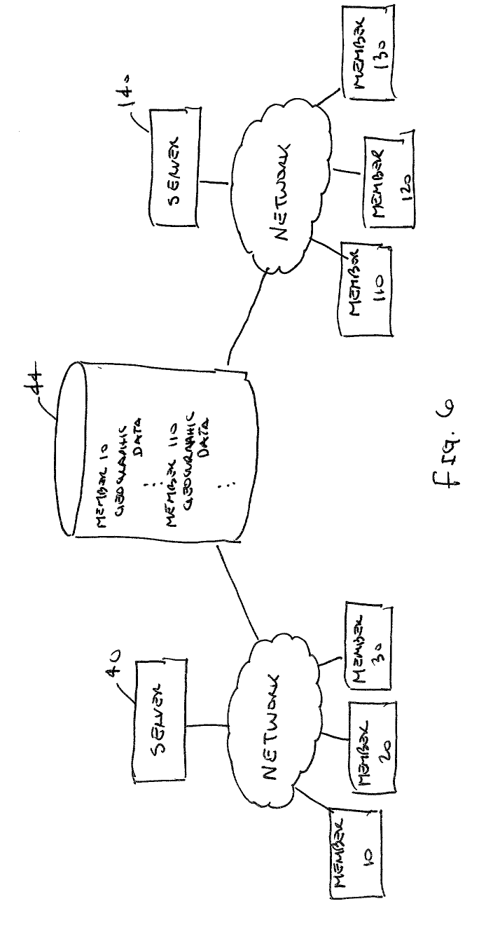

Turning to FIG. 6, another exemplary architecture is shown for searching for individuals sharing travel-related interests, in accordance with the present invention. A first plurality of members lo-n are connected to a first server 40 via a network 50. The first server 40 may be operated by a first online community, e.g., a first dating service, and may be connected to a member database 44, either directly or via the network 50. Similarly, a second plurality of members 110-130 are connected to a second server 140 via the network 50. The second server 140 may be operated by a second online community, and may also be connected to the member database 44, either directly or via the network 50.

Each of the first and second communities may include any number of members, and any number of online communities may be provided that are connected to or otherwise have access to the member database 44.

The member database 44 is preferably a shared travel-related database that stores geographic data and personal information related to the members 10-n and 110-130. The member database 44 may include a search engine (not shown) or each of the servers 40, 140 may include a search engine for submitting search requests and/or receiving search results from the member database 44.

Preferably, each of the members 10-n, 110-130 submits geographic data, e.g., residence location data, general travel-related data, and/or specific travel plan data, that has been compiled into the member database 44. The geographic data may be entered and/or updated by individual members, similar to the methods described above. The member database 44 may also generally be searched similar to the methods described above.

Unlike the previous embodiment, however, the geographic data and/or personal information of each of the members 10-n, 110-130 is preferably associated with a surrogate identifier. Surrogate identifiers may be selected by respective members or may be assigned by the member database 44 and/or the servers 40, 140. The surrogate identifiers generally do not identify the online communities with which the respective members are members. The system operates similar to the previously described embodiment, except that any lists of search results include the surrogate identifiers of members included in the list and not other personal identifiers, e.g., membership aliases, e-mail addresses, etc.

This arrangement serves several useful functions. First, it provides an additional level of anonymity for all of the members involved in the travel-networking mechanism. Because only the surrogate identifiers are provided to searching members, communication between members may be monitored and/or controlled by the member database 44 and/or the respective servers 40, 140. Thus, members may safely initiate contact or respond to contacts initiated by others without divulging their addresses or other direct contact information.

In addition, the surrogate identifier mechanism requires members to retain membership in their respective online communities. This may prevent members circumventing their online communities and/or substantially reduce the risk of participating online communities losing members to other online communities. The member database 44 may operate substantially independently from each of the online communities, thereby allowing the online communities to share information without jeopardizing their memberships.

A central travel-related database may be particularly useful, because a large critical mass of participants may be desirable in order for the database to function optimally. If multiple online communities “share” their members with one another, the database may more effectively provide a diverse geographic community. Thus, members from one online community may submit search requests for individuals traveling or interested in specific travel destinations, and obtain search results including members from one or more different online communities.

For example, with reference to FIG. 6, if a first member 10 decides to initiate contact with a second member 130 found during such a search, a message may be sent from the first member 10. Because the search result identifies the second member 130 only by their surrogate identifier, the message must be sent to the server 40. The server 40 may determine the true identity and/or address of the second member 130, e.g., by consulting the member database 44. The server 40 may then forward the message via the network 50 to the server 140, with a “return address” identifying the first member 10 only by their surrogate identifier. The server 140 may then send the message to the second member 130. Any response from the second member 130 to the first member 10 is transmitted similarly, with the response being received by the server 140 and forwarded to the server 40 for delivery to the first member 10.

While embodiments of the present invention have been shown and described, various modifications may be made without departing from the scope of the present invention, and all such modifications and equivalents are intended to be covered.

1. A method for initiating contact between a first member of a social community residing at a first geographic location and a second member of the social community residing at a second geographic location based upon common travel-related interests, using a member database comprising identities of members and geographic data related to respective members, the geographic data comprising residence locations of the respective members and travel destinations of interest to the respective members, the method comprising:
identifying a travel destination of interest to the first member, the identified travel destination being different from at least one of the first and second destinations;
submitting a search request to the member database for members having an association with the identified travel destination;
receiving a list comprising a group of members having an association with the identified travel destination, the group including the second member; and
sending a message to the second member, the message comprising information related to the identified travel destination.

2. The method of claim 1, wherein the search request further comprises a date restriction, and wherein the list comprises a group of members whose geographic data indicate that the respective members will be present at the identified travel destination at a time included within the date restriction.

3. The method of claim 2, wherein the message comprises a notice that the first member will be at the identified travel destination during a time within the date restriction.

4. The method of claim 1, wherein the identified travel destination comprises a geographic location to which the first member plans to travel.

5. The method of claim 4, wherein the search request further comprises a request for members who also plan to travel to the identified travel destination.

6. The method of claim 4, wherein the search request further comprises a request for members who also plan to travel to the identified travel destination at a time within a predetermined date restriction.

7. The method of claim 4, wherein the identified travel destination comprises the second geographic location.

8. The method of claim 1, wherein the identified travel destination comprises the first geographic location, and wherein the search request further comprises a request for members planning to travel to the first geographic location.

9. The method of claim 1, further comprising submitting geographic data comprising one or more travel destinations to which the first member intends to travel.

10. The method of claim 1, wherein the search request comprises one or more personal parameters to further limit members included in the list.

11. The method of claim 10, wherein the personal parameters comprise at least one of age, appearance, marital status, sexual preferences, interests, hobbies of the members that may be included in the list.

12. A system for facilitating contact between members of a social community residing at different geographic locations, based upon shared travel-related interests, comprising:
a member database comprising identities of members and geographic data related to respective members, the geographic data comprising residence locations of the respective members and travel destinations of interest to the respective members;
a search engine for searching the member database for members satisfying submitted search requests;
an interface for receiving a search request from a first member searching for other members having an association with a travel destination, the interface configured for submitting a list comprising a group of identities of members having an association with the travel destination, the group including a second member; and
a message server for conveying a message from the first member to the second member.

13. The system of claim 12, wherein the member database further comprises data indicating times when respective members will be at respective travel destinations.

14. The system of claim 13, wherein the search engine is configured for searching the member database for members who will be at respective travel destinations at times within a selected date restriction.

15. The system of claim 12, wherein the member database further comprises surrogate identities for members whose geographic data is included in the member database.

16. The system of claim 15, wherein the list comprises a group of surrogate identities of members having an association with the travel destination, and wherein the message server is configured for determining an address for the second member based upon a surrogate identity included in the message.

17. A method for facilitating contact between members of a social community residing at different geographic locations based upon shared travel-related interests, the method comprising:
providing access to a member database comprising identities of members and geographic data related to respective members, the geographic data comprising residence locations of the respective members and travel destinations of interest to the respective members;
receiving a search request from a first member searching for other members having an association with a travel destination;
searching the member database for members satisfying the search request;
sending a list to the first member, the list comprising a group of identities of members having an association with the travel destination, the group including a second member;
receiving a message from the first member intended for the second member; and
sending the message to the second member.

18. The method of claim 17, wherein the member database further comprises data indicating times when respective members will be at respective travel destinations.

19. The method of claim 18, wherein the search request further comprises a data restriction, and wherein the searching step comprises searching the member database for members who have indicated that they will be present at the travel destination at a time including within the date restriction.

20. The method of claim 19, wherein the message comprises a notice that the first member will be at the travel destination during a time within the date restriction.

21. The method of claim 17, wherein the travel destination comprises a travel destination to which the first member plans to travel.

22. The method of claim 21, wherein the search request further comprises a request for members who also plan to travel to the travel destination.

23. The method of claim 21, wherein the search request further comprises a request for members who also plan to travel to the travel destination at a time within a predetermined date restriction.

24. The method of claim 17, wherein the travel destination comprises a residence location of members to be included in the list.

25. The method of claim 17, wherein the travel destination comprises a residence location where the first member resides, and wherein the search request further comprises a request for members planning to travel to the residence location.

26. The method of claim 17, wherein the list comprises a group of surrogate identities of members having an association with the travel destination, and wherein the sending step comprises determining an address for the second member based upon a surrogate identity included in the message.

27. The method of claim 17, wherein the search request further comprises one or more personal parameters associated with members of interest to the first member.

28. The method of claim 27, wherein the searching step comprises searching the member database for members meeting the personal parameters included in the search request.

29. A method for facilitating contact between members of a social community residing at different geographic locations based upon shared travel-related interests, the method comprising:
providing access to a member database comprising surrogate identities of members, and geographic data related to respective members, the geographic data comprising residence locations of the respective members and travel destinations of interest to the respective members;
receiving a search request from a first member requesting other members having an association with a travel destination;
searching the member database for members satisfying the search request;
sending a list to the first member, the list comprising a group of surrogate identities of members having an association with the travel destination, the group including a second member;
receiving a message from the first member addressed to the surrogate identity of the second member; and
determining a true identity of the second member based upon the surrogate identity; and
sending the message to the second member.

30. The method of claim 29, wherein the social community comprises a plurality of member communities, wherein the member database further comprises true identities associating members with their respective member communities.

31. The method of claim 30, wherein the message comprises a surrogate identity of the first member.

32. The method of claim 31, further comprising:
receiving a response from the second member addressed to the surrogate identity of the first member;
determining a true identity of the first member based upon the surrogate identity; and
sending the response to the first member.

33. A method for initiating contact between members of a social community residing at different geographic locations based upon shared travel-related interests, the method comprising:
providing a member database comprising identities of members and geographic data related to respective members, the geographic data comprising intended travel destinations of the respective members and dates of intended travel to respective travel destinations;
receiving a search request from a first member comprising an identified travel destination and a date restriction;
searching the member database for members intending to travel to the identified travel destination at a time within the date restriction; and
sending a list to the first member, the list comprising a group of identities of members intending to travel to the identified travel destination at a time within the date restriction.

34. The method of claim 33, further comprising:
receiving a message from the first member intended for the second member; and
sending the message to the second member.

35. The method of claim 33, wherein the search request further comprises one or more personal parameters associated with members of interest to the first member, and wherein the searching step comprises searching the member database for members satisfying the personal parameters included in the search request.
